(19) United States
(12) Patent Application Publication
(10) Pub. No.: US 2024/0121269 A1
(43) Pub. Date: Apr. 11, 2024

(54) Client Entity Validation with Session Tokens Derived From Underlying Communication Service Values

(71) Applicant: Akamai Technologies, Inc., Cambridge, MA (US)

(72) Inventor: Eric Elbaz, Miami, FL (US)

(21) Appl. No.: 17/938,386

(22) Filed: Oct. 6, 2022

(51) Int. Cl. H04L 9/40

(52) U.S. Cl. CPC H04L 63/166; H04L 63/0435; H04L 63/0876

(57) ABSTRACT

The generation and use of session tokens in a computer networking environment is disclosed. Such session tokens can be used in a variety of ways, such as to validate client identity and entitlement to resources, for security assessment, or in other trust establishment mechanisms. Preferably, the session token generation algorithm incorporates one or more non-ephemeral value(s) that are established for a given communication session between two hosts. To validate a token presented by a client, for example, a server can check it against the session values actually in use to communicate with the client.

### BACKGROUND

### Technical Field

This application generally relates to creation of session tokens for clients that are highly resistant to forgery or misuse, and to the use of such tokens in various applications related to computer networking.

### Brief Description of the Related Art

Credential and link sharing plagues content providers and rights holders, and is a ubiquitous challenge to content protection generally on the Internet.

Token ‘replay’ attacks are a primary mechanism for malicious actors to steal and misuse credentials. The basis of stream-ripping, stream-rebroadcasting and link sharing exploitation of streaming media and other online protected content uses session token ‘replay’ to bypass authorization and authentication requirements and impersonate the original user who initiated the session.

Stopping content pirating requires hardening tokens to prevent abuse. At the same time, session token generation and validation should be stateless, because relying on a stateful solution (such as a centralized database) does not scale to meet the needs of today's highly distributed streaming infrastructures.

Prior approaches in this area include generating session tokens based on IP addresses, or on application layer 7 information such as user agent, client application or device data, content provider secrets, and/or end-user logins. Many of these elements are relatively easy to forge and are not tied to a given session. Moreover, current approaches often scale poorly in distributed systems because of the need to distribute and maintain secrets across many machines.

Token hardening is also relevant to network security, including API security, bot detection and tracking, and client fingerprinting. More generally, hardened tokens can be used in virtually any service that issues or validates client credentials to manage entitlement to resources.

The teachings hereof address the foregoing problems, among others, and enable new digital rights management, security, and secure content delivery solutions. The teachings hereof improve the functioning of a computer system itself, including authentication and authorization functions, in both individual servers and in larger distributed systems with many such servers. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of any issued patent define the scope of protection.

The generation and use of session-specific tokens in a computer networking environment is disclosed. Session tokens can be used in a variety of ways, such as to validate a client entity and entitlement to resources, for security assessment, or in other trust establishment contexts. Preferably, the session token generation algorithm incorporates one or more non-ephemeral values(s) that are established at the initiation of, or otherwise during, a given communication session between two hosts. The values are ‘non-ephemeral’ in the sense that they persist to support communication after their creation (e.g., after the initial handshake that initiates the session). Preferably the non-ephemeral value(s) are integral to the communication service providing the session; they are “integral” in the sense that the values must be used by the communication service to operate successfully between the two hosts. The two hosts might be client and server, or peer to peer, for example.

In one embodiment, a client application (on one host) and a server application (on another host) may rely on an underlying TLS implementation to provide encrypted transport layer communication services. The TLS session is initiated with a cryptographic handshake, such as a TLS handshake, during which certain non-ephemeral values are negotiated, such as cryptographic operating modes, parameters, and key material. Certain of these values are secret and are generated specifically for the session, such as a master secret, shared key, or session identifier. As is known in the art, the values negotiated in the TLS handshake are used to facilitate the subsequent encrypted message exchange within that session.

In accordance with the teachings of this document, one or more of such TLS values can be incorporated into a session token. Further, such TLS values first may be included in or used to derive a data structure, such as a TLS session ticket or pre-shared key extension field, and then that data structure (and by extension the values within it) can be incorporated into the session token.

There are many ways to incorporate such values into a token but one example is a cryptographic hash or digest (e.g., a hashed message authentication code or HMAC). The use of material from the underlying TLS service (or more generally, any underlying communication service) inextricably ties the token to the session and mitigates against forgery. Of course, the input to the hash may include other data as desired, be it from the transport layer, application layer, or otherwise as known in the art.

To validate a token presented by a client, a server can check it against the session parameters actually being used to communicate with that client. A match indicates a valid token, while a mismatch means the token is invalid. A token replay attack would fail because the attacker's session would not be presenting the same values established in the original handshake.

The teachings hereof are not limited to any specific underlying or supporting communication service between hosts.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a block diagram illustrating a process for generating a session token, in accordance with one embodiment of the teachings hereof;

FIG. 2 is a block diagram illustrating a process for validating a session token, in accordance with one embodiment of the teachings hereof;

FIG. 3 is a sequence diagram illustrating the generation of a session token in a streaming multimedia use case, in accordance with one embodiment of the teachings hereof;

FIG. 4 is the same as FIG. 3 except that it contains an explanatory arrow to illustrate aspects of the generation of a session token, in accordance with one embodiment of the teachings hereof;

FIG. 5 is a sequence diagram illustrating the validation of a session token in a streaming multimedia use case, in accordance with one embodiment of the teachings hereof; and,

FIG. 6 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms, such as HTML, URL, XML, AJAX, CSS, HTTP versions 1.1, 2, and 3, MQTT, TCP/IP, and UDP, is assumed.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Implementing hardware may be actual or virtualized.

### Introduction

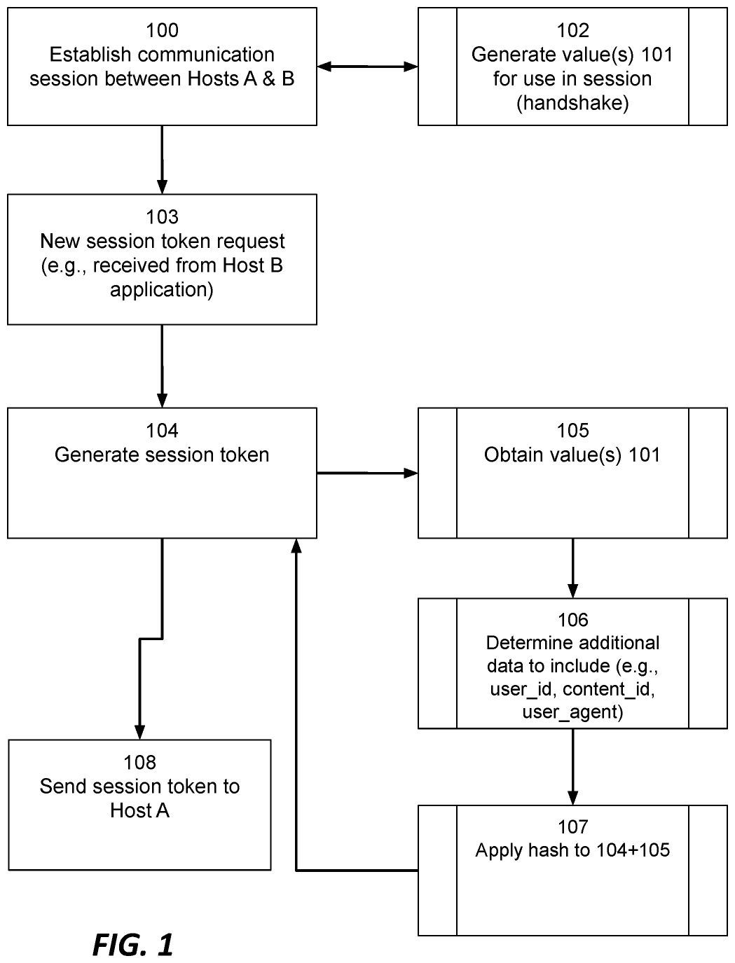

FIG. 1 is a general depiction of a process for generating a session token in accord with one embodiment of the invention. FIG. 1 is intended to introduce general concepts of the solution and is not limited to a particular protocol; more specific embodiments will be presented later.

The process begins when two hosts A and B establish a communication session (100), typically via an exchange of messages which is often referred to as a handshake. The handshake process results in the generation of certain non-ephemeral values (101) for the session that will be used in-session to communicate (102) thereafter.

Assume that, at some point in the session, it is determined that a session token is needed for Host A. For example, an application running on Host B may determine that the end user and/or user application on Host A has successfully completed an authentication process, an authorization and/or content-entitlement process, or other similar event, and will need a session token (102) to include with future requests to Host B to enable client validation.

The session token generation algorithm (103) is illustrated generally by substeps (104-106). One or more of the values (101) is obtained by the token generation algorithm (104). This means the values (101) must be exposed from the code that provides the underlying communication session to the session token generation code. In some embodiments this involves providing a hook for the application layer (token generation) in Host B to be able to make a call into a lower layer (communication session) to obtain the information.

It is preferable to use values (101) that were generated specifically for the session. Some values from the handshake merely represent a selection from a small set of predetermined values (e.g., choosing a cryptographic mode); this does not provide a high level of security for creating a session token as compared to a new value generated for the session. In some embodiments, depending on the level of hardening desired, it is possible to use a session value that was selected in the handshake from a large set of predetermined values. Or, an embodiment might use a concatenated superset of the selected value of multiple options set by handshake (e.g., an example is the use of a TLS fingerprint, which is presented in more detail later in this document).

The values (101) may be combined with other data prior to hashing (105). Virtually any additional data could be used and it will be dictated by the design goals of the implementation (105). For example, additional data may be static values, client-specific values, end user specific, content specific, or otherwise. User identifiers, IP addresses, content identifiers, token issuer identity, timestamps, and similar items are examples.

The vector of values (101) plus additional data (106) is then fed into a one-way cryptographic hash (e.g., SHA-256) to generate the session token. Hence, an example of the general form of a session token is:
Session_token=user-id+content-id+timestamp+HMAC (session-values+additional-data+timestamp)

Note, however, that the teachings hereof are not limited to the above hashing algorithm or approach.

The resulting session token is returned to Host A (107). The method of placing the session token on Host A may be accomplished in a variety of ways such as in an HTTP payload or special header, in a cookie, or otherwise.

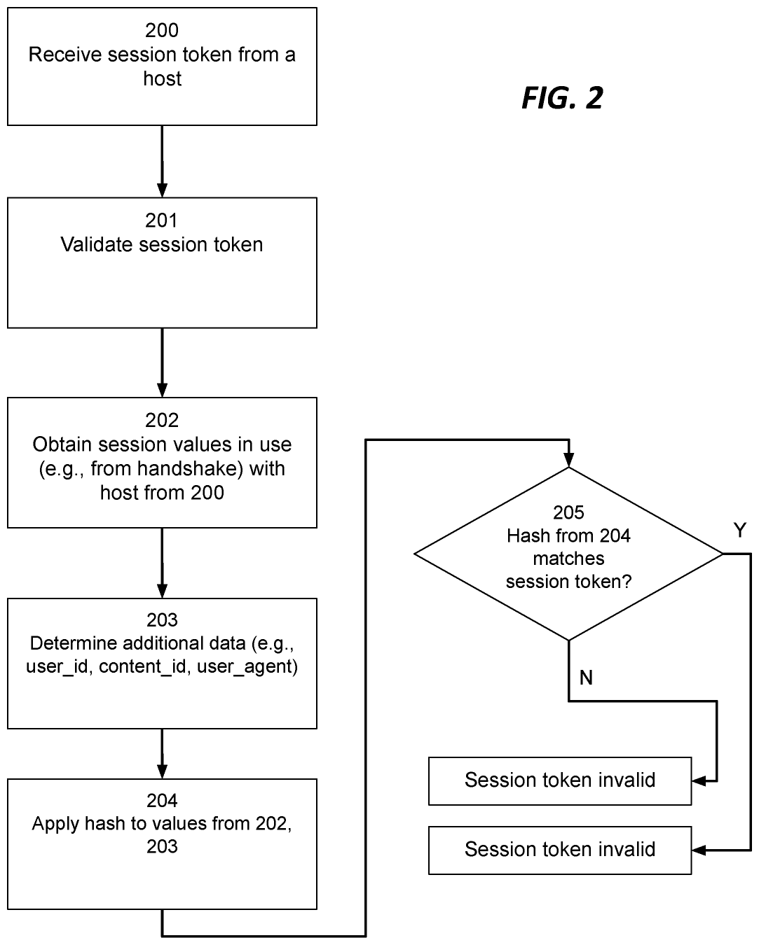

FIG. 2 is a general depiction of a process for validating a session token in accord with one embodiment of the invention. Again it is intended to introduce general concepts of the solution and is not limited to a particular protocol; more specific embodiments will be presented below.

FIG. 2 begins with a session token being received within a given communication session with another host (200). The validation process is invoked (201). The process involves obtaining the appropriate session values(s) (202) and additional data (203) that are actually in use from the active session with the client device that just sent the session token. The hash algorithm (204) is applied to this information from the currently active session. The result is compared against the session token to determine whether the session token is valid (205). In effect, the validity of the session token proves that the active session values (e.g., the shared key or parameters) are the same as those from the original establishment of the session, via the initial handshake.

With the foregoing by way of introduction, more detailed embodiments are now presented to illustrate potential uses of the invention.

Session Tokens for Streaming Multimedia

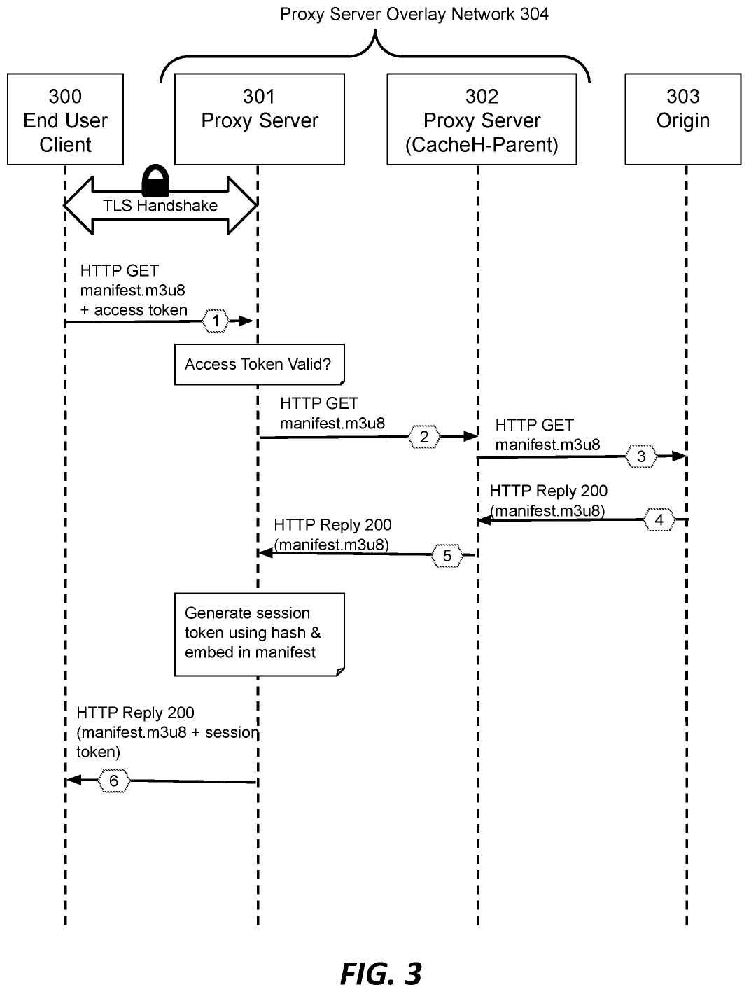

FIG. 3 illustrates an embodiment of the invention in which a session token is used in a multimedia streaming solution. In this example, assume use of the TLS and HTTP protocols in a segmented HTTP streaming solution. One can also assume that a TCP or any other general purpose transport protocol is in use, such as DTLS (TLS over UDP), FTP, or otherwise.

Before turning to FIG. 3, a brief overview of certain concepts relevant to this embodiment is provided. In conjunction with a transport protocol connection, two network hosts can perform an additional TLS handshake to establish a secure (encrypted) session; that handshake establishes the cryptographic operating modes, parameters, and key material used for further message exchange between the two hosts. The current version of the TLS protocol is 1.3. More recently, the QUIC protocol has become popular. QUIC uses the TLS protocol, but it replaces the TCP handshake and TLS handshake into one handshake, as it assumes all sessions will be secured via encryption. The IETF has published RFC 9114, which relies on aspects of QUIC to describe HTTP/3.

If a TLS session (whether riding on top of TCP or otherwise) is paused or interrupted, it can be restarted through a process known as session resumption. The goal of session resumption is to tie the new message exchange to the original secure communication context—put another way, to continue the conversation between the client and server—by reusing values negotiated in the original TLS handshake. An early technique for session resumption is the session identifier, which is a value chosen by the server to uniquely identify the session. The session identifier must be maintained by both client and server.

TLS v1.2 introduced the concept of a session ticket. A session ticket is a data structure that the server encrypts with a private key and sends to the client for storage thereon. The server is thus relieved of the burden of storing this information. When the client wants to resume a session, it presents its session ticket to the server as part of the TLS handshake. The server extracts the information stored in the session ticket (e.g., shared key, cipher settings, other state information) and uses it in an abbreviated handshake to resume the session. In TLS v1.3, the session ticket approach is replaced with a pre-shared key (PSK) extension field.

Internet Engineering Task Force (IETF) RFCs 4507, 5077, 5426, and 8446 describe the TLS protocol, TLS session resumption, session tickets, pre-shared keys, and related topics, and this document should be read in conjunction with that background material.

Turning to FIG. 3, assume that the end user client (300) is running a player application that will request and display a multimedia stream to the end user. The proxy server network (304) is a content delivery network (CDN) having a distributed set of proxy servers (301-302) that fetch manifest files and multimedia segments from the origin 303 and distribute them to requesting end user clients (300).

In the context of FIG. 3, the delivery process begins when the end user client (300) initiates a TLS session with a proxy server (301). As mentioned earlier, a TLS session may be initiated on top of a variety of transport protocols; this example is agnostic to the underlying transport mechanism and so it is not depicted in the diagram.

Within the encrypted session (in the encrypted messages at the TLS record layer), step 1, the end user client (300) issues an HTTP GET for the manifest of the stream that the end user desires. The client (300) presents an access token that the content provider (of the multimedia stream) has issued to it, preferably in an out-of-band process for authentication and content entitlement. In FIG. 3, proxy server (301) validates the access token. Assuming the access token is valid, the proxy server (301) sends a forward request (HTTP GET shown at step 2) for the manifest file to a cache parent (302), which in turn queries the content provider origin (303) at step 3. (This flow assumes that the manifest is not in cache so the proxies 301 and 302 experience cache misses.)

At steps 4-5, the manifest is returned to the proxy server (301), being cached along the way. The proxy server (301) now needs to invoke the session ticket generation algorithm.

Non-ephemeral values from established TLS session are now used to generate the session ticket. Example values include: master secret, key, session ID. Another example is to use a data structure such as a session ticket or PSK extension field, which is derived from such values.

In this embodiment, assume that the proxy server (301) has generated a TLS session ticket or pre-shared key for session resumption and shared them with the client (300). Hence, the session ticket or PSK extension field can be exposed to the session ticket generation algorithm and used as a seed in the hash, in the manner explained earlier with respect to FIGS. 1-2. The output of the hash (with any other additional contextual data that may be desired) forms the session ticket or at least a portion of it.

At step 6 in FIG. 3, the proxy server (301) serves the manifest to the client (300) along with the session token in the HTTP Reply. Note that the TLS implementation in the proxy server (301) would separately communicate the session ticket or PSK value to the client, in accord with the standard; however that communication is not shown in FIG. 3.

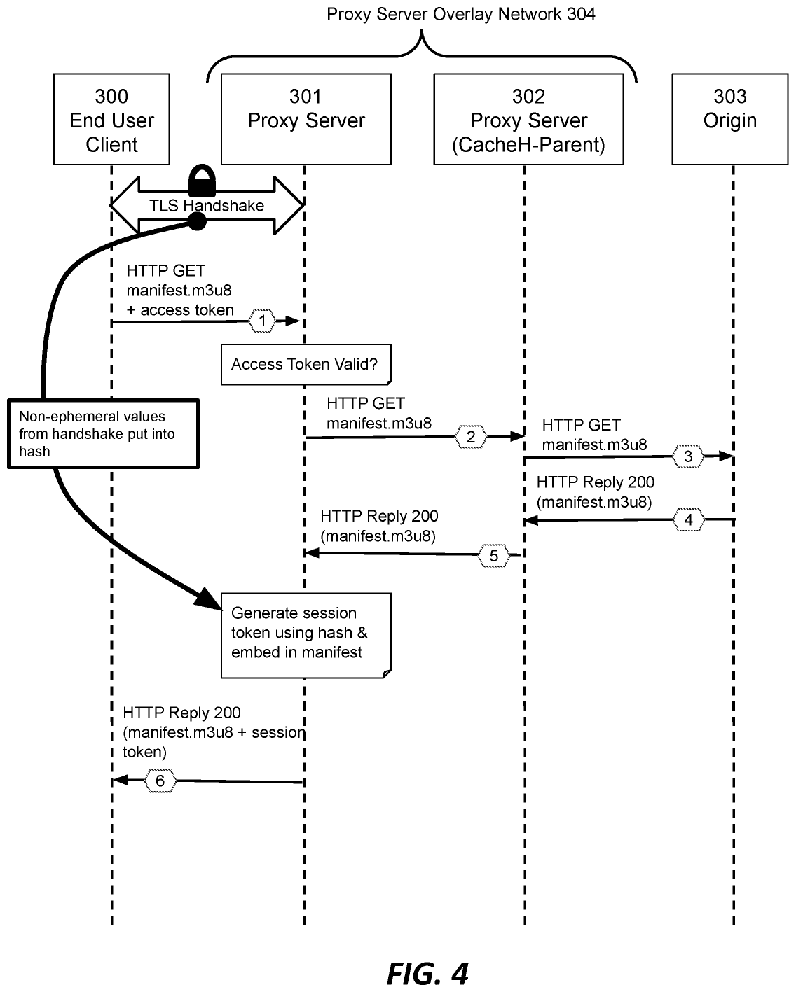

FIG. 4 is the same as FIG. 3 however it includes an arrow emphasizing how the TLS values are exported into the session ticket generation process operating at the application layer.

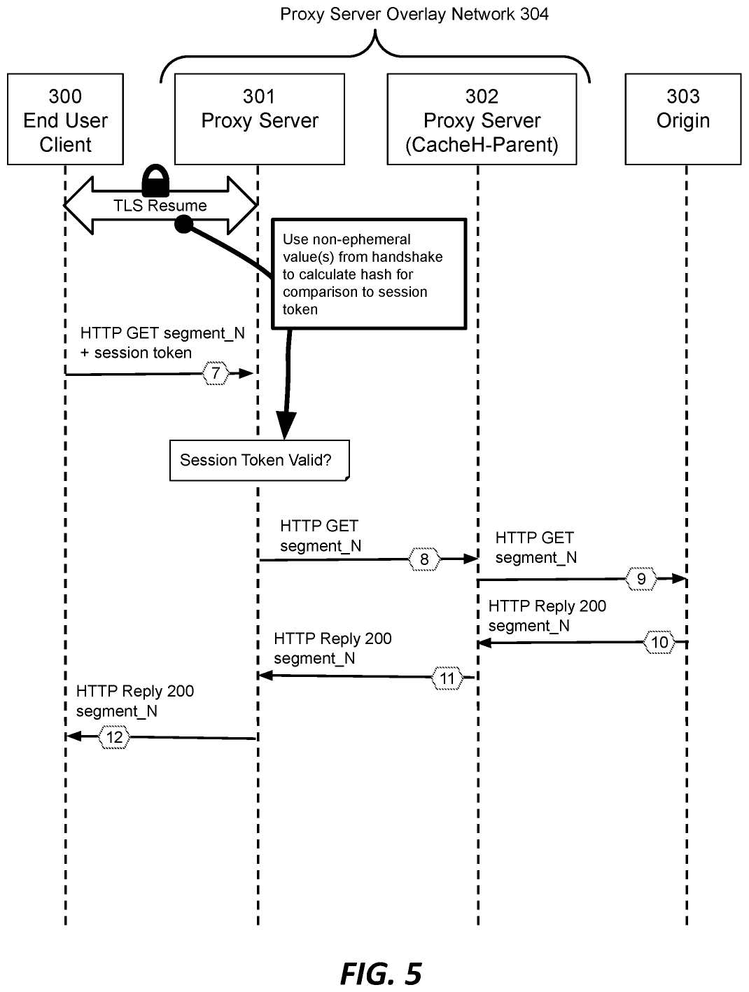

FIG. 5 continues with the embodiment illustrated in FIGS. 3 and 4, moving forward in time to illustrate the process of validating the session token.

Assume that after the events shown in FIG. 3, the TLS session is paused (e.g., because the TCP connection is closed). The sequence illustrated in FIG. 5 begins with the resumption of the TLS session. The client (300) sends the session ticket or PSK value (depending on the version of TLS in operation) to resume the session.

After the TLS session is resumed, the client (300) sends an HTTP GET for a segment of the multimedia stream that had begun playing (step 7). The client attaches the session token to this request. The proxy server (301) invokes a session token validation routine. The validation routine is an application layer process, in this embodiment. It obtains the relevant TLS session values from the TLS stack, which include either the session ticket or PSK. That is, the TLS values actually in use with the client (300) that has presented the token are obtained. The proxy server hashes (301) this information (along with any other additional values defined in the session token algorithm) as explained earlier. If the hashes match, then the end user client (300) must be the same client that originally established the TLS session in FIG. 3, and the session token is valid. If not, the proxy server (301) rejects the token and the request (not shown). FIG. 5 assumes that the token is valid, so the proxy server (301) goes forward to a cache hierarchy parent (302) and origin (303) to fetch the requested segment of the multimedia stream (steps 8 through 11).

In step 12, the segment is served to the client (300).

It should be appreciated that FIG. 5 assumes a TLS resumption due to connection close, but that may not be the case. In many cases, after the end user client 300 receives the manifest in FIG. 3, the end user client 300 may simply begin requesting segments (step 7, FIG. 5) in the same TLS session. However, the session token can be validated in a similar way, e.g., by extracting the relevant TLS values in use for the current session, and using them to create a hash digest to see if it matches the session token.

Use of TLS Fingerprint in Session Token

It is known in the art to use TLS connection information to create a “TLS fingerprint” that facilitates bot detection. The TLS fingerprint can be created from a variety of parameters in the client's initial “Hello” packet, such as: record layer version, client version, ordered TLS extensions, ordered cipher list, ordered elliptic curve list, and ordered signature algorithms list. More information about the creation and use of TLS fingerprints can be found in U.S. Pat. No. 11,184,390, titled “Bot Detection in an Edge Network Using Transport Layer Security (TLS) Fingerprint”, issued Nov. 23, 2021, the entire contents of which are hereby incorporated by reference.

In one embodiment according to the teachings of this document, a TLS fingerprint is used as a seed in the generation of the session token. That is, a TLS fingerprint can be captured from the client in the TLS handshake and that information can be hashed into the session token for use as described in this document. A TLS fingerprint can be sufficiently unique to provide token security for some design cases, even if it does not include a value specific to a given session like a master secret or shared key.

Access to Resources

The issuance and validation of the session token as taught herein can be used to confer or prove entitlement to any resource, not just a segment of a multimedia stream. The resource may be content or a service (e.g., an API to which the end user client has successfully authenticated and authorized).

Other Non-Ephemeral Values

While this document has provided a variety of examples of non-ephemeral values from a communication session, it should be understood that such examples are provided for illustration and as such are not limiting to the teachings hereof. Other values from session initiation may be used depending on the particular design goals and use cases, including future versions of session tickets, pre-shared keys, or other session resumption facilitators, TCP fast open cookies, and so on.

Use in Content Delivery Networks

The teachings hereof are applicable to (but not limited to) content delivery systems. Background on state of the art content delivery systems, including as used for delivering streaming media, can be found in the following documents, the teachings of all of which are hereby incorporated by reference in their entireties: U.S. Pat. Nos. 9,532,092 and 8,769,614 and 8,291,504, as well as U.S. Pat. Nos. 6,108,703; 7,293,093; 7,096,263; 7,096,266; 7,484,002; 7,523,181; 7,574,499; 7,240,100; 7,603,439; 7,725,602; 7,716,367; 7,996,531; 7,925,713; 7,058,706; 7,251,688; 7,274,658; 7,912,978; 8,195,831.

Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

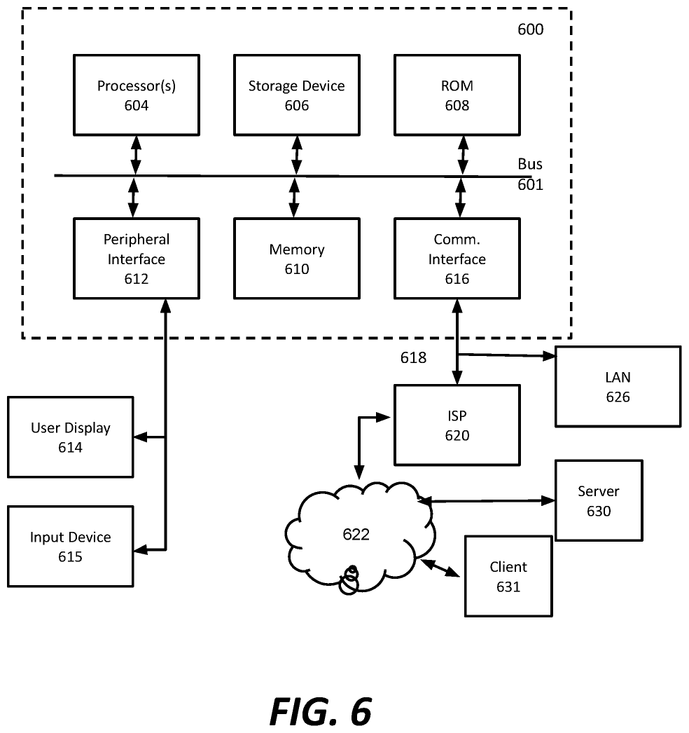

FIG. 6 is a block diagram that illustrates hardware in a computer system 600 upon which such software may run in order to implement embodiments of the invention. The computer system 600 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 600 includes a microprocessor 604 coupled to bus 601. In some systems, multiple processor and/or processor cores may be employed. Computer system 600 further includes a main memory 610, such as a random access memory (RAM) or other storage device, coupled to the bus 601 for storing information and instructions to be executed by processor 604. A read only memory (ROM) 608 is coupled to the bus 601 for storing information and instructions for processor 604. A non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

A peripheral interface 612 may be provided to communicatively couple computer system 600 to a user display 614 that displays the output of software executing on the computer system, and an input device 615 (e.g., a keyboard, mouse, trackpad, touchscreen) that communicates user input and instructions to the computer system 600. However, in many embodiments, a computer system 600 may not have a user interface beyond a network port, e.g., in the case of a server in a rack. The peripheral interface 612 may include interface circuitry, control and/or level-shifting logic for local buses such as RS-485, Universal Serial Bus (USB), IEEE 1394, or other types of communication links.

Computer system 600 is coupled to a communication interface 616 that provides a link (e.g., at a physical layer, data link layer) between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the processor executing code. Such code may be read from or stored on a non-transitory computer-readable medium, such as memory 610, ROM 608, or storage device 606. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 618 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method by which a first host generates a session token for a second host, comprising:
participating in a handshake with a second host to initiate a session between the first host and the second host;
obtaining one or more non-ephemeral values from the handshake;
providing the one or more non-ephemeral values to a token generation algorithm that operates separately from the execution of the handshake;
the token generation algorithm:
(i) applying a cryptographic function to the one or more non-ephemeral values to produce an output, and,
(ii) generating a session token for the second host based on the output of the cryptographic function; and,
sending the session token to the second host.

2. The method of claim 1, wherein the one or more non-ephemeral values were generated during the handshake.

3. The method of claim 2, wherein the one or more non-ephemeral values comprise secrets generated during the handshake.

4. The method of claim 1, wherein the one or more non-ephemeral values comprise a set of parameters exhibited by the second host during the handshake.

5. The method of claim 4, wherein the set of parameters represents a TLS fingerprint.

6. The method of claim 1, wherein the token generation algorithm further comprises: applying the cryptographic function to one or more application layer values along with the one or more non-ephemeral values to produce the output.

7. The method of claim 1, wherein the session comprises any of: a TCP session, a TLS session.

8. The method of claim 1, wherein the handshake comprises a transport layer security (TLS) handshake.

9. The method of claim 1, wherein the handshake comprises a set of messages that result in the generation of the one or more non-ephemeral values, which are subsequently used for communication within the session.

10. The method of claim 1, where providing the one or more non-ephemeral values to the token generation algorithm comprises providing any of the following:
master secret,
key,
session identifier,
session ticket, and,
pre-shared key extension field.

11. The method of claim 1, wherein the cryptographic function comprises a hash function.

12. The method of claim 1, wherein the session token confers entitlement to a resource that the first host requests from the second host.

13. The method of claim 12, wherein the resource comprises at least a portion of a multimedia stream.

14.-27. (canceled)

28. A system, comprising:
a first host having circuitry forming one or more processors and memory storing code for execution on the one or more processors so as to cause the first host to operate as specified in any of the preceding claims; and
a second host having circuitry forming one or more processors and memory storing code for execution on the one or more processors so as to cause the second host to operate as specified in any of the preceding claims.

29. A non-transitory computer readable medium providing instructions for execution on a hardware processor to cause one or more computers to operate in accord with any of the preceding claims.
